(19) United States
(12) Patent Application Publication
(10) Pub. No.: US 2003/0046294 A1
(43) Pub. Date: Mar. 6, 2003

(54) Symmetrical database data set allocation

(75) Inventor: Scott D. Heronimus, Sugar Land, TX (US)

Correspondence Address: WONG, CABELLO, LUTSCH, RUTHERFORD & BRUCCULERI,, P.C., 20333 SH 249, SUITE 600, HOUSTON, TX, 77070, US

(73) Assignee: BMC Software, Inc., Houston, TX

(21) Appl. No.: 10/230,566

(22) Filed: Aug. 29, 2002

Related U.S. Application Data
(60) Provisional application No. 60/316,408, filed on Aug. 31, 2001.

(51) Int. Cl. G06F 7/00

(52) U.S. Cl. 707/100

(57) ABSTRACT

Techniques to allocate storage space for database data sets based on the database's internal/logical boundaries is described. Metadata describing the structure and logical size requirements for various database sections are interrogated and used to guide the allocation of physical storage space on one or more storage devices. Data set extents allocated in symmetry with database internal boundaries can improve the physical database's input-output performance and storage device utilization.

This application claims priority on the U.S. provisional application entitled “Symmetrical Database Data Set Allocation” by Scott Heronimus, serial No. 60/316,408, filed Aug. 31, 2001.

### FIELD OF THE INVENTION

This invention relates to a method and apparatus for the allocation of database data sets. More particularly but not by way of limitation, this invention relates to a method and apparatus for allocating database data sets in symmetry with the internal logical database dimensions or boundaries of associated database control blocks.

### BACKGROUND

Information Management System (“IMS”) databases by International Business Machines Corporation of Armonk, N.Y. are among the oldest and most widely used database systems. IMS are based on the hierarchical data model and typically run under the OS/390 and z/OS operating systems on large IBM 370/390 and like mainframe computers. Queries to an IMS database are issued through embedded calls in a host language such as the IMS database language DL/I.

Because performance is critically important in large databases, IMS provides the database designer a large number of options in its data definition language. The database designer defines a physical hierarchy as the database schema. Several subschemas may be defined by constructing a logical hierarchy from the segment types comprising the schema. There are a variety of options available in the data definition language that allow the database administrator to “tune” the system for improved performance (e.g. block sizes, special pointer fields, etc.). As such, an IMS database management system provides an assortment of hierarchical database schemas that support a variety of features and functions. One characteristic that is common to each of these database types is the storing of the actual data into database data sets. The allocation schemes of these data sets have little or no correlation to the internal boundaries within their associated database definitions.

Databases are defined in IMS by the Database Description control block (“DBD”). The DBD specifies the required geometry, attributes and access method to be used for the underlying database data set. Access methods are typically Virtual Storage Access Method (“VSAM”) or Overflow Sequential Access Method (“OSAM”). A data set is usually established by invoking operating system services to allocate storage space on Direct Access Storage Devices (“DASD”). The size of a data set is defined by the amount of primary, and optionally secondary, space quantities. In the past, such space quantities have generally been arbitrary, static values that have no relationship to the associated DBD apart from the necessity of meeting the minimum required size of the database.

Once the primary quantity (or extent) of a data set has been allocated, additional extents can then be requested and acquired. The size of a secondary extent, when allocating to additional DASD volumes, is either a secondary quantity (if specified) or a primary quantity, depending upon the particular access method that is used. In the past, the size of a secondary extent has had no direct relationship to its associated DBD. Furthermore, uniformly sized secondary extents can continue to be acquired until the DASD space is exhausted or the maximum number of extents has been reached. IMS database data set extent sizes are independent from any parameters defined within its associated DBD.

In the past, a database administrator (“DBA”) has predetermined the allocation and size of database data sets. The DBA would either communicate with the database application developer to determine how much space the total application would require or the DBA would estimate the required space based on experience. The DBA may then pad this estimate to ensure that the application has enough space to run. The DBA would then invoke operating system services to allocate this space on one or more DASDs. Often the allocation is based on administrative ease or expedience.

While this method has generally worked, it has created problems that adversely effect database input/output (I/O) performance and DASD usage. For example, because a DBA may allocate space on a single DASD the database I/O performance may be limited by device's throughput. As a result, highly active databases that are not allocated on a sufficient number of DASD volumes may suffer significant delays in I/O service time due to channel and device contention. Additionally, because a DBA may allocate a certain amount of space for an entire database, if the database does not use all of the space that is allocated to it, the space is wasted, resulting in DASD usage inefficiencies. As a result, substantial portions of DASD volumes may remain unutilized because remnants of volume space are too small to accommodate large allocation requests.

Therefore, the prior art methods of determining the size and allocation of database data sets can result in database I/O constraints and DASD usage inefficiencies. Techniques in accordance with the invention solve these problems by providing an improved system and method for allocating database data sets in symmetry with the internal logical dimensions or boundaries associated with the database description control blocks. Furthermore, the present invention provides a dynamic method of adjusting the size of a physical data set extent to match the internal dimensions of a logical data structure.

### SUMMARY

In one embodiment the invention provides a method to allocate storage space for a database data set. The method includes obtaining internal boundary information associated with the database data set, requesting storage space approximately equal to that of an internal boundary identified in the internal boundary information, receiving the requested storage space and associating the received storage space with the database data set. The method is applicable to hierarchical and relational databases and, in some embodiments, utilizes operating system services or utilities to obtain and associated the requested storage space with the database data set. The method may be stored in any media that is readable and executable by a computer system.

In another embodiment, the invention provides a method to adjust the size of a physical data set extent of a database's data set to correspond to one or more of the database's logical internal boundaries. The method includes scanning internal boundary information for the database data set, wherein the internal boundary information identifies the logical size of one or more sections of the database data set. The method further includes acquiring storage space approximately equal in size to a first section, accepting the storage space on a first direct access storage device and connecting the accepted storage space to the database. The method is applicable to hierarchical and relational databases and, in some embodiments, utilizes operating system services or utilities to obtain and associated the requested storage space with the database data set. The method may be stored in any media that is readable and executable by a computer system.

### BRIEF DESCRIPTION OF THE DRAWINGS

A better understanding of the present invention can be obtained when the following detailed description is considered in conjunction with the following drawings:

FIG. 1 is a block diagram illustrating Data Entry Database (“DEDB”) sections that have been allocated across three different Direct Access Storage Device (“DASD”) volumes based on the internal logical structure of the DEDB sections.

FIG. 2 is a block diagram illustrating Hierarchical Direct Access Method (“HDAM”) sections that have been allocated across three different DASD volumes based on the internal logical structure of the HDAM sections.

FIG. 3 is a block diagram illustrating a Hierarchical Indexed Direct Access Method (“HIDAM”) data component that has been allocated across three different DASD volumes based on the internal logical structure of the HIDAM's data section.

FIG. 4 is a flow chart illustrating a database data set allocation process in accordance with one embodiment of the invention.

FIG. 5 is a flow chart depicting a detailed illustration of the physical allocation process illustrated in FIG. 4.

FIG. 6 is a flow chart depicting a detailed illustration of the data set extension process illustrated in FIG. 4.

### DETAILED DESCRIPTION

In accordance with one aspect of the invention, logical boundaries identified in Database Description (“DBD”) blocks are used to guide the physical allocation of database data sets. One embodiment of the invention is implemented as a software utility that is executed before running an application program (e.g. a program that uses the underlying database). For ease of description, the following embodiments are described in terms of the following three IMS databases: Data Entry Database (“DEDB”); Hierarchical Direct Access Method (“HDAM”); and Hierarchical Indexed Direct Access Method (“HIDAM”). All of which typically exercised from within an associated mainframe operating systems such as OS/390 and z/OS provided by IBM corporation of Armonk, N.Y. Each of these database types has its own peculiar characteristics which will be described separately as they relate to symmetrical database data set allocation. However, as one of ordinary skill in the art will appreciate, the principles of the present invention are not limited in application to the foregoing three IMS databases, and specifically, the inventive techniques are applicable to other databases that include an internal logical structure such as relational databases, for example, DB2 by the IBM Corporation or Oracle databases by the Oracle corporation of Redwood City, Calif.

In one embodiment of the invention, database data set extents are allocated in symmetry with the internal boundaries of an associated DBD, thus improving both physical database I/O performance and Direct Access Storage Device (“DASD”) volume utilization. Highly active databases are typically allocated across multiple DASD volumes to distribute the database's I/O demand to a broader array of I/O paths. Such disparate access paths can be exploited by initiating parallel I/O operations under certain access methods. Under the principles of the present invention, symmetrical database data set extents can be considerably smaller than the primary space quantities used in prior art database data set allocations. Reducing primary space quantities can, in turn, reduce the demand for large and contiguous portions of DASD space, thereby affording smaller and more numerous allocations that result in higher DASD utilization. Correspondingly, remnant space on DASD volumes can be used more frequently, resulting in greater DASD economy and efficiency.

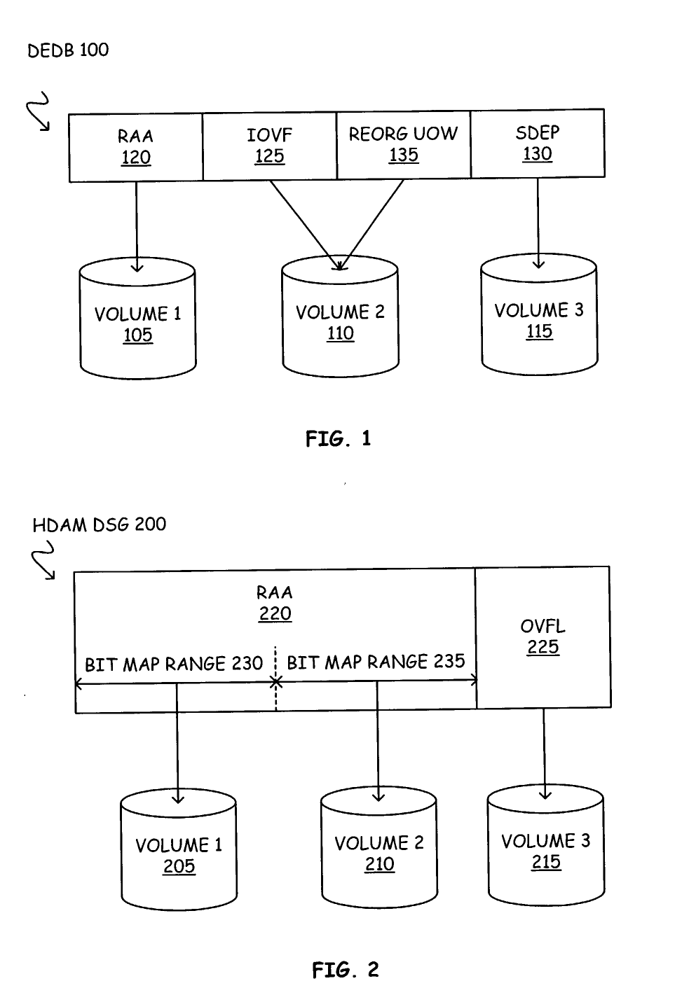

With respect to Data Entry Databases (“DEDBs”), one of ordinary skill in the art will recognize that a DEDB is composed of a number of physical partitions called “areas.” An area comprises three (3) primary sections: (1) the Root Addressable Area (“RAA”) section; the Independent Overflow (“IOVF”) section; and the Sequential Dependent (“SDEP”) section. Referring to FIG. 1, a block diagram illustrating DEDB 100 that has been allocated across three (3) different DASD volumes 105, 110 and 115 based on the internal logical structure of the DEDB's sections is shown. As illustrated, each section is sequentially adjacent to the other when physically stored in a Virtual Sequential Access Method (“VSAM”) Entry Sequence Data Set (“ESDS”). The internal boundaries between these sections are explicitly defined within the DBD. The size of RAA section 120 can be computed from this boundary information and used as the primary space quantity for allocating a first extent of the area's data set. The size of IOVF section 125 can be similarly calculated and used to allocate a secondary extent on the same or a different DASD volume. Similarly, SDEP section 130 can be factored from the Reorganization Unit Of Work (“REORG UOW”) section 135 and used to allocate another secondary extent onto the same or yet another DASD volume. When the allocation process is complete in accordance with the invention, DEDB area 100 can be wholly contained within a single VSAM ESDS that spans multiple DASD volumes. As illustrated, irregular data set extents allocated in accordance with the invention can be configured to closely approximate the storage dimensions for each of the unique sections within DEDB area 100.

Referring again to FIG. 1, in one embodiment of the invention a software utility reads information stored in a DBD and requests space from the operating system. Initially, the utility initiates a request to the operating system to allocate a primary extent that is equal in size to that which the DBD indicates is necessary for RAA section 120. The operating system examines the allocation request and allocates space on first DASD 105. If the allocated space is enough for the entire database, then the utility is finished. If more space is necessary, the utility can initiate another request to the operating system to allocate a secondary extent that is equal in size to that which the DBD indicates is necessary for IOVF section 125 and REORG UOW 135. The operating system examines the second allocation request and allocates space on second DASD 110. Once again, if the allocated space is enough for the entire database, the utility is finished. If still more space is necessary, the utility can initiate a third allocation request to the operating system to allocate a tertiary extent that is equal in size to that which the DBD indicates is necessary for SDEP section 130. The operating system examines the third allocation request and allocates space on third DASD 115. After the tertiary extent is allocated, no additional space need be allocated for the database.

With respect to Hierarchical Direct Access Method (“HDAM”) databases, one of ordinary skill in the art will recognize that HDAM databases are composed of two (2) primary sections: (1) a HDAM RAA section; and (2) a HDAM OVFL section. Referring to FIG. 2, a block diagram illustrating HDAM 200 that has been allocated across three (3) different DASD volumes 205, 210 and 215 based on the internal logical structure of the HDAM's sections is shown. It will be recognized that HDAM databases may also be considered to have logical divisions along the internal boundaries between its “bit maps.” Bit maps are dedicated records within a HDAM database that contain a string of bits indicating the space availability of the succeeding storage locations that it addresses. As shown, HDAM RAA section 220 is sequentially adjacent to OVFL section 225 when physically stored in primary Data Set Group (“DSG”) 200, which is backed by either a VSAM ESDS or an Overflow Sequential Access Method (“OSAM”) data set. HDAM databases can also support a number of secondary DSGs that have the same storage characteristics as their HDAM OVFL section such as, for example, OVFL section 225. The internal boundaries between these sections are explicitly defined within the HDAM DBD. Specifically, the size of HDAM RAA section 220, or the first bit map's range 230, can be computed from this boundary information and used as the primary space quantity for allocating the first extent of primary HDAM DSG data set 200. The size of HDAM OVFL section 225, or of subsequent bit map ranges (e.g., bit map range 235), can be similarly calculated and used to allocate a secondary extent for primary HDAM DSG 200 onto the same or a different DASD volume. When the allocation process is complete in accordance with the invention, the HDAM database's primary DSG 200 can be wholly contained within a single VSAM or OSAM data set that spans multiple DASD volumes as shown in FIG. 2. As illustrated, the irregular data set extents allocated in accordance with the invention can be configured to closely approximate the storage dimensions of the unique sections or internal boundaries within the HDAM database.

Typically, HDAM RAA section 220 is spanned to be a variable number of bit map ranges, while HDAM OVFL section 225 is the residual balance of the database. As such, the size of HDAM RAA section 220 can be computed from the boundary information and used as the primary and the secondary space quantities for allocating the beginning extents of HDAM database data set 200. The size of the HDAM OVFL section 225 can also be computed from the boundary information contained in the database's DBD and used as the tertiary space quantity for allocating a third extent of HDAM database data set 200.

Referring again to FIG. 2, in another embodiment of the invention a software utility initiates an allocation request to the operating system for a primary extent, which is equal in size to the addressable range of the first bit map in the HDAM RAA section, e.g. bit map range 230 in RAA section 220. The operating system examines the allocation request and allocates space on first DASD 205. If the allocated space is enough for the entire database, the utility is finished. If more space is necessary, the utility initiates a second allocation request to the operating system for a secondary extent, which is equal in size to the addressable range of subsequent bit map 235 in HDAM RAA section 220. The operating system can then examine the second allocation request and allocate space on second DASD 210. If the allocated space is enough for the entire database, the utility is finished. If still more space is necessary, the utility initiates a third allocation request to the operating system to allocate a tertiary extent, which is equal in size to that which the HDAM DBD indicates is necessary for HDAM OVFL section 225. The operating system examines the third allocation request and allocates space on third DASD 215. After the tertiary extent is allocated, no additional space is allocated for the database.

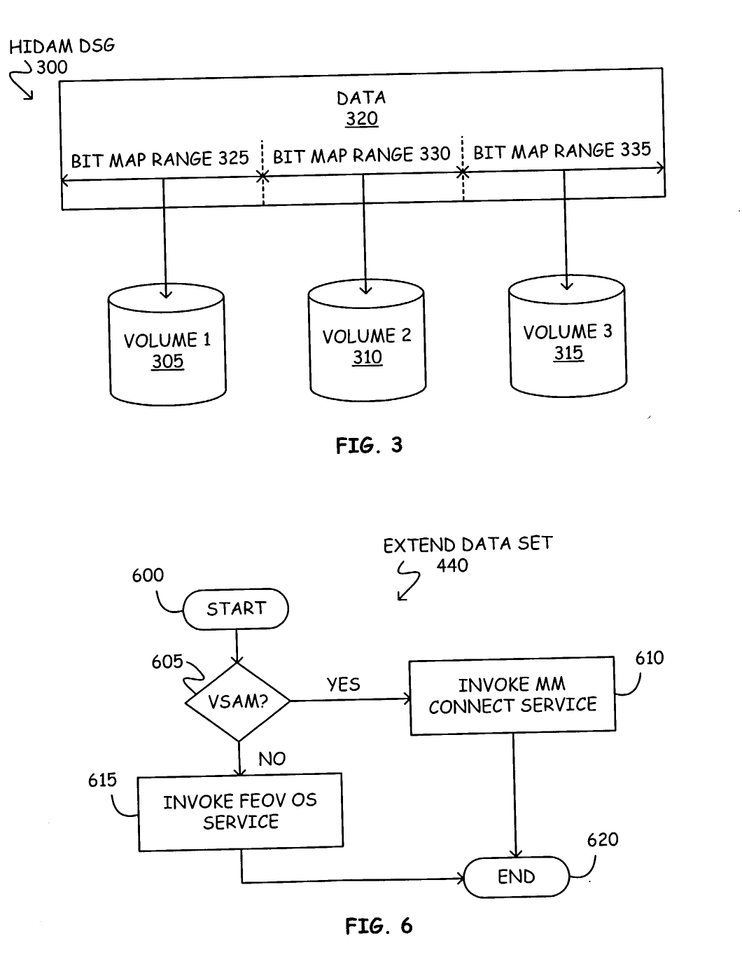

With respect to Hierarchical Indexed Direct Access Method (“HIDAM”) databases, one of ordinary skill in the art will recognize that HIDAM databases are composed of two primary sections: (1) an index section; and (2) a data section. Referring to FIG. 3, a block diagram illustrating HIDAM data set group (“DSG”) 300 that has been allocated across three (3) different DASD volumes 305, 310 and 315 based on the internal logical structure of the HIDAM's data section 320 is shown. It will be recognized that HIDAM bit maps are dedicated records within the database that contain a string of bits indicating the space availability of succeeding storage locations that it address (see discussion above). As illustrated, bit maps 325, 330 and 335 are successively arranged with the storage locations and are physically stored in HIDAM DSG 300, which may be backed by a VSAM ESDS or an OSAM data set. As with other databases, HIDAM's can support a number of secondary DSGs that have the same storage characteristics as primary DSG 300, the internal boundaries of which are typically, and explicitly, defined within the HIDAM's DBD. Referring again to FIG. 3, first bit map 325 can be computed from this boundary information and used as the primary space quantity for allocating a first extent of DSG data set 300. Subsequent bit map ranges 330 and 335 can be similarly used to calculate and allocate additional secondary extents for primary DSG 300 onto the same or different DASD volumes, e.g., DASD volumes 310 and 315. When the allocation process is completed, a HIDAM database's primary DSG can be wholly contained within a single VSAM or OSAM data set that spans multiple DASD volumes. As illustrated, the irregular data set extents allocated in accordance with the invention can be configured to closely approximate the storage dimensions of the unique internal boundaries within HIDAM database 300. In a typical embodiment, HIDAM data section 320 is spanned to be a variable number of bit map ranges. As such, the size of data section 320 may be computed from the boundary information and used as the primary and the secondary space quantities for allocating the extents of the HIDAM database data set 300.

Referring again to FIG. 3, in yet another embodiment of the invention, a software utility initiates an allocation request to the operating system for a primary extent, which is equal in size to the bit map range 325 in HIDAM data component 320. The operating system examines the allocation request and allocates space on first DASD 305. If the allocated space is enough for the entire database, the utility is finished. If more space is necessary, the utility initiates a second allocation request to the operating system for a secondary extent, which is equal in size to the addressable range of subsequent bit map range 330 in HIDAM data component 320. The operating system examines the second allocation request and allocates space on second DASD 310. If the allocated space is enough for the entire database, the utility is finished. If still more space is necessary, the utility can initiate a third allocation request to the operating system for a tertiary extent, which is equal in size to the addressable range of bit map range 335 in HIDAM data component 320. The operating system examines the third allocation request and allocates space on third DASD 315. After the tertiary extent is allocated, no additional space need be allocated for the database.

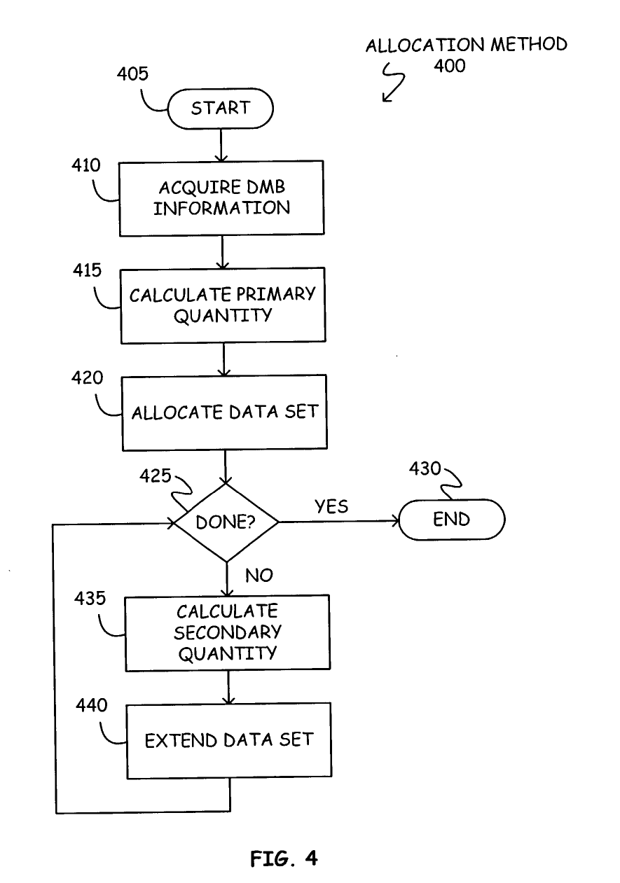

Referring to FIG. 4, allocation method 400 in accordance with the invention is described as it relates to each of the above-described database types: DEDB, HDAM and HIDAM (see FIGS. 1 through 3). In some embodiments, method 400 may be implemented as a software tool that assists a Database Administrator (DBA) in allocating database data sets according to the principles of the invention.

After initialization by a user such as a DBA (block 405), the database's Data Management Block (“DMB”) is interrogated (block 410). The DMB is a structure defined by IMS that describes a database's logical structure and its physical attribute. It will be recognized by those of ordinary skill that databases other than IMS have similar structures to provide such information. Following DMB interrogation, a primary data set allocation quantity is calculated from information contained in the DMB (block 415). One of ordinary skill in the art will recognize that in an IMS environment, the DMB is a processed version of the DBD, incorporating substantially the same information as the DBD. The calculated primary data set allocation quantity may be used for the initial database data set allocation (block 420). For example, if the database is a DEDB or HDAM database, the primary quantity used will typically be based on the size of the RAA section (see FIGS. 1 and 2). If, on the other hand, the database is a HIDAM database, the calculated primary quantity will generally be based on the size of a first bit map range in the HIDAM data component (see FIG. 3). Next, the allocated data set's high allocation address is checked against the required high allocation quantity in the DMB. If the data set is sufficiently large and no additional storage is needed (the “YES” prong of diamond 425), method 400 is complete (block 430). If the allocated data set is not sufficiently large (the “NO” prong of diamond 425), a secondary allocation quantity may be calculated (block 435) based on, for example, the size of the OVFL section if the database is a HDAM or HIDAM database or the addressable range of a subsequent bit map if the database is a HIDAM database. Once calculated, storage is allocated to create a secondary quantity that is used to extend the database's data set's size (block 440). The acts of blocks 425 through 440 are repeated as necessary to allocate the needed storage.

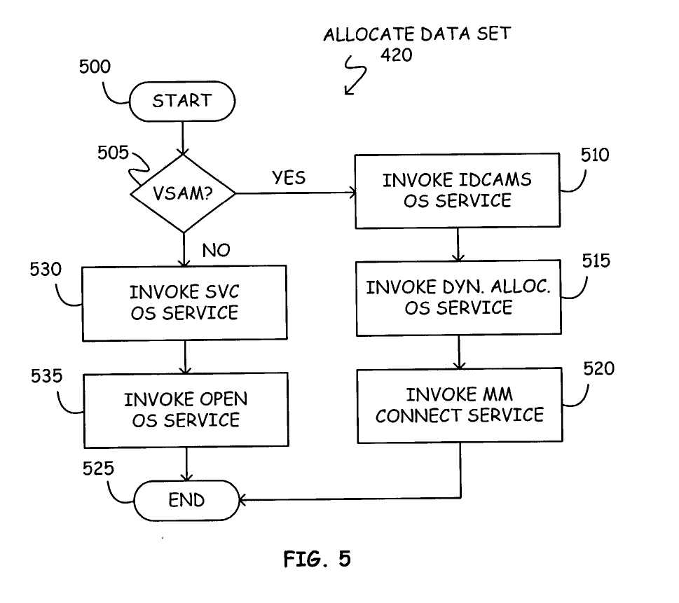

Referring now to FIG. 5, the physical allocation act of block 420 in FIG. 4 is discussed in further detail. After storage allocation initialization (block 500), database data set allocation begins by determining from the DMB whether the data set should be a VSAM or OSAM data set (diamond 505). As discussed above, databases are stored in predetermined data sets. For example, a DEDB may be stored in VSAM data sets, while HDAM and HIDAM databases may be stored in either VSAM or OSAM data sets. If a database is to be stored in a VSAM data set (the “YES” prong of diamond 505), the VSAM data set can be established on a DASD by invoking the operating system service known as IDCAMS in the, for example, OS/390 and z/OS environments (block 510). Once the VSAM file has been established, it can be associated with the allocation process by means of the operating system dynamic allocation system service (block 515). Next, the operating system's Media Manager service can be invoked to connect the newly allocated storage space of the VSAM data set for further processing (block 520). Once the VSAM data set has been physically allocated and connected, the physical allocation process is complete and control is transferred back to block 425 of FIG. 4 (block 525). If a database is to be stored in an OSAM data set (the “NO” prong of diamond 505), the OSAM data set can be established on a DASD by invoking the SVC operating system service in the OS/390 and z/OS environment (block 530). Next, the operating system OPEN data management service can be used to open the newly allocated OSAM data set for further processing (block 535). This operation is analogous to the VSAM operation of block 520. Once the OSAM data set has been physical allocated, the physical allocation process is completed and control is transferred back to block 425 of FIG. 4 (block 525).

Referring now to FIG. 6, the physical database data set extension acts of block 440 in FIG. 4 is discussed in further detail. After storage extension initialization (block 600), database data set extension begins by determining from the DMB whether the data set should be a VSAM or OSAM data set (diamond 605). If the data set is to be a VSAM data set (the “YES” prong of diamond 605), the operating system Media Manager service can be used to extend the VSAM data sets according to the previously calculated secondary quantity size (block 610). If the data set is not to be a VSAM data set (the “NO” prong of diamond 605), the FEOV operating system data management service may be invoked to extend OSAM data sets (block 615). In accordance with the FEOV service, the secondary quantity size is placed in the data set's Job File Control Block (“JFCB”) to specify the size of the extent. Following the acts of blocks 610 and 615, data set extend operations are complete (block 620) and control is passed back to block 425 of FIG. 4.

It should be noted that the amount of space requested for an extent by a method in accordance with the invention does not always match the actual amount allocated by the operating system. For example, in a DEDB, if the DBD indicates that 18 tracks of space are necessary for the RAA section, and the method of FIGS. 4 through 6 requests 18 tracks for the primary extent, the operating system may allocate, for example, 20 tracks instead of the requested 18 tracks. This is because the operating system may enforce its own integral space allocation boundaries.

A model will now be examined according to the principles of the invention to illustrate the benefits associated therewith. Assume that the present model applies to an automatic teller machine (“ATM”) transaction application program using an IMS DEBD database. It will be understood and appreciated by those of ordinary skill that millions of transactions associated with ATM activity take place daily making it difficult for the DBA to tune the performance of the database and administer its space allocation.

To assist the DBA, a software utility in accordance with the invention may be executed before an ATM transaction application is started. The utility uses the information stored in the ATM's DEDB DBD (or alternatively, the DMB) to request a suitable amount of space from the operating system. The DBD indicates the amount that the database will require. For the purposes of this example, assume that the RAA section indicates 250 tracks, the IOFV section indicates 75 tracks, and the SDEP section indicates 50 tracks. The utility can acquire and use the DBD information to determine a primary quantity based on the database's internal boundaries (see block 410 of FIG. 4). As described above, for a DEDB the RAA section corresponds to the primary quantity. Accordingly, the primary quantity request is 250 tracks (see block 415 of FIG. 4). Before the quantity can be requested, the utility determines from the DBD that the data set is a VSAM data set (see block 420 of FIG. 4 and, in particular, block 505 of FIG. 5). Accordingly, the IDCAMS operating system service can be used to establish a 250-track VSAM data set on a first DASD (see block 510 of FIG. 5). Next, a dynamic allocation system service can be used to associate the new data set with the utility (see block 515 of FIG. 5) and an Media Manager service can be used to connect the data set to the utility (see block 520 of FIG. 5). Following this initial storage space allocation, the data set's resultant high allocation is checked against the required high allocation quantity in the DBD for the entire database, which is equal to the sum of the DEDB Area portions or 375 tracks (see block 425 of FIG. 4). Because the data set is not yet sufficiently large (i.e., 250<375), a second quantity is calculated based on the ATM's DEDB IOVF section (see block 435 of FIG. 4). Unlike the first allocation, however, the Media Manager requests the secondary quantity and the operating system allocates 100 tracks on a second DASD (see blocks 510-520 of FIG. 5). Once again, the data set's resultant high allocation is checked against the required high allocation quantity in the DBD for the entire database, which is equal to the sum of the DEDB Area portions or 375 tracks (see block 425 of FIG. 4). Because the data set is still not sufficiently large (i.e., 350<375), a tertiary quantity is calculated (see block 435 of FIG. 4). The DBD now shows that the SDEP section needs 50 tracks. If the SDEP section is used to request the tertiary quantity, 50 tracks will be requested, making the possible total amount of space allocated for the database 400 tracks, or 25 tracks in excess of what the DBD specifies is necessary. However, if desired, the DBA may elect to manually override the SDEP request and make a request for 25 tracks. Moreover, whatever size request is made, the resultant quantity is still subject to the operating system's integral space allocation boundaries. Similar to the second allocation, the Media Manager requests the tertiary quantity and the operating system allocates 50 tracks on a third DASD (see blocks 510-520 of FIG. 5). As before, the data set's resultant high allocation is checked against the required high allocation quantity in the DBD for the entire database, which is equal to the sum of the area portions or 375 tracks (see block 425 of FIG. 4). Because the data set is sufficiently large (i.e., 400>375), the utility is exited and the ATM transactions application is started (see block 430 of FIG. 4).

As can be seen, symmetrical database data set allocation is a useful solution for addressing physical database I/O congestion and DASD space utilization problems. This allocation scheme can be effectively incorporated into the function of a database load or initialization utility program. The sequential processing associated with database load and/or initialization utilities is an ideal environment for programmatically allocating data sets extents that are in accordance with a database's internal boundaries. These tailored database data sets allocations will consequently enhance physical I/O performance and improve DASD space efficiency.

It will be appreciated by those of ordinary skill having the benefit of this disclosure that the illustrative embodiments described above are capable of numerous variations without departing from the scope and spirit of the invention. For example, while the present invention has been described using IMS, other databases, such as relational databases may be utilized. For example, a simple (or unsegmented) tablespace is a relational construct that is composed of rows of data from one or more tables that have been physically mapped to a linear data set. Relational database “space maps” are dedicated pages within the tablespace that contain bit strings that indicate space availability for the succeeding data pages that it addresses—similar in concept to IMS bit maps (see discussion above). The range of storage between different space maps provides a predictable internal boundary that can be used to symmetrically allocate the physical extents of the underlying data set. Similarly, in a segmented tablespace rows of data from one or more tables are grouped in page-segments of varying sizes and mapped to a linear data set. Segmented tablespace space maps are typically subdivided by page-segments and contain control bytes and bit strings that indicate space availability for the succeeding data pages that it addresses. The storage range between the segmented tablespace space maps provide a predictable internal boundary that can be used to symmetrically allocate the physical extents of the underlying data set. Accordingly, the exclusive rights to be patented are all claims that may be patented based on the disclosure of the present invention as described herein.

What is claimed is:

1. A method of allocating storage space for a database data set, comprising:
obtaining internal boundary information associated with a database data set;
requesting a first storage space approximately equal to a first internal boundary identified in the internal boundary information;
receiving the requested storage space; and
associating the received storage space with the database data set.

2. The method of claim 1, wherein the act of obtaining internal boundary information comprises obtaining information identifying size requirements for each of a plurality of sections for a database's primary data set.

3. The method of claim 1, wherein the act of obtaining internal boundary information comprises obtaining a database description control block information associated with the database data set.

4. The method of claim 3, wherein the act of obtaining internal boundary information comprises scanning a database management block associated with the database data set.

5. The method of claim 2, wherein the plurality of sections comprise a root addressable area section and an overflow section.

6. The method of claim 2, wherein the plurality of sections comprise an index section and a data section.

7. The method of claim 2, wherein the size of at least one of the plurality of sections is further described by one or more bit map ranges.

8. The method of claim 1, wherein the act of requesting comprises requesting an operating system provide the requested storage space.

9. The method of claim 1, wherein the act of receiving comprises receiving storage associated with a direct access storage device.

10. The method of claim 1, wherein the act of requesting further comprises requesting a second storage space approximately equal to a second internal boundary identified in the internal boundary information.

11. The method of claim 10, wherein the act of receiving comprises:
receiving the first requested storage associated with a first direct access storage device; and
receiving the second requested storage associated with a second direct access storage device.

12. The method of claim 1, wherein the acts of obtaining, requesting and associating are directed to a data set for an Information Management System database.

13. The method of claim 12, wherein the acts are further directed to obtaining and associating storage space for a database selected from the group consisting of a Data Entry Database, a Hierarchical Direct Access Method database and a Hierarchical Indexed Direct Access Method database.

14. The method of claim 1, wherein the act of requesting comprises determining whether the database data set is a Virtual Storage Access Method data set.

15. The method of claim 1, wherein the act of associating comprises invoking a Media Manager service to open the accepted storage space.

16. The method of claim 1, wherein the acts of obtaining, requesting and associating are directed to storage space for a relational database data set.

17. A method to adjust the size of a physical data set extent to correspond to the internal dimensions of a logical boundary associated with the data set, comprising:
scanning internal boundary information for a database data set, the internal boundary information corresponding to one or more sections of the database data set;
acquiring storage space approximately equal in size to a first section;
accepting the storage space on a first direct access storage device; and
opening the accepted storage space.

18. The method of claim 17, wherein the act of scanning comprises scanning database description control block information associated with an Information Management System database.

19. The method of claim 18, wherein the act of scanning database description control block information comprises scanning a database management block.

20. The method of claim 18, wherein the act of scanning comprises determining a logical boundary size for a root addressable area of the database data set and the act of acquiring storage space comprises acquiring storage space approximately equal to the logical boundary size of the root addressable area section.

21. The method of claim 18, wherein the act of scanning comprises determining a logical boundary size for an overflow area of the database data set and the act of acquiring storage space comprises acquiring storage space approximately equal to the logical boundary size of the overflow section.

22. The method of claim 18, wherein the act of acquiring storage space comprises:
requesting the storage space from an operating system; and
receiving indication of the requested storage space from the operating system.

23. The method of claim 22, further comprising:
comparing the size of the acquired storage space with the total space required by the database data set as indicated by the database description control block information; and
acquiring additional storage space approximately equal to the difference between the acquired storage space and the total space required by the database data set.

24. The method of claim 23, wherein the act of acquiring additional storage space comprises issuing one or more requests for said additional storage space from the operating system.

25. The method of claim 24, wherein the act of accepting additional storage space comprises accepting storage space on a second direct access storage device, wherein the second direct access storage device is different from the first direct access storage device.

26. The method of claim 18, wherein the acts of scanning and acquiring are directed to a database selected from the group consisting of a Data Entry Database, a Hierarchical Direct Access Method database and a Hierarchical Indexed Direct Access Method database.

27. The method of claim 17, wherein the act of acquiring storage space comprises determining whether the database data set is a Virtual Storage Access Method data set.

28. The method of claim 17, wherein the act of connecting comprises invoking a Media Manager service to open the accepted storage space.

29. A program storage device, readable by a programmable control device, comprising instructions stored on the program storage device for causing the programmable control device to:
obtain internal boundary information associated with a database data set;
request a storage space approximately equal to a first internal boundary identified in the internal boundary information;
receive the requested storage space; and
associate the received storage space with the database data set.

30. The program storage device of claim 29, wherein the instructions to obtain internal boundary information comprise instructions to obtain a database description control block information associated with the database data set.

31. The program storage device of claim 30, wherein the instructions to obtain a database description control block information comprise instructions to obtain a database management block associated with the database data set.

32. The program storage device of claim 30, wherein the instructions to obtain internal boundary information comprise instructions to obtain boundary information corresponding to a bit map range for at least one section of the database data set.

33. The program storage device of claim 29, wherein the instructions to request comprise instructions to invoke operating system services.

34. The program storage device of claim 29, wherein the instructions to receive comprise instructions to receive storage associated with a direct access storage device.

35. The program storage device of claim 29, wherein the instructions to request further comprise instructions to request a second storage space approximately equal to a second internal boundary identified in the internal boundary information.

36. The program storage device of claim 29, wherein the instructions to obtain, request and associate are instructions directed to a data set for an Information Management System database.

37. The program storage device of claim 36, wherein the instructions to obtain and associate are further directed to obtain and associate storage space for a database selected from the group consisting of a Data Entry Database, a Hierarchical Direct Access Method database and a Hierarchical Indexed Direct Access Method database.

38. The program storage device of claim 29, wherein the instructions to request comprise instructions to determine whether the database data set is a Virtual Storage Access Method data set.

39. The program storage device of claim 17, wherein the instructions to associate comprise instructions to invoke a Media Manager service to connect the accepted storage space to the database data set.

40. The program storage device of claim 29, wherein the acts of obtaining, requesting and associating are directed to storage for a relational database.

41. A program storage device, readable by a programmable control device, comprising instructions stored on the program storage device for causing the programmable control device to:
scan internal boundary information for a database data set, the internal boundary information corresponding to one or more sections of the database data set;
acquire storage space approximately equal in size to a first section;
accept the storage space on a first direct access storage device; and
open the accepted storage space.

42. The program storage device of claim 41, wherein the instructions to scan comprise instructions to scan a database description control block associated with an Information Management System database.

43. The program storage device of claim 42, wherein the instructions to scan comprise instructions to determine a logical boundary size for a root addressable area of the database data set and the instructions to acquire storage space comprises acquiring storage space approximately equal to the logical boundary size of the root addressable area section.

44. The program storage device of claim 42, wherein the instructions to scan further comprise instructions to determine a logical boundary size for an overflow area of the database data set and the instructions to acquire storage space further comprise instructions to acquire storage space approximately equal to the logical boundary size of the overflow section.

45. The program storage device of claim 42, wherein the instructions to acquire storage space comprise instructions to:
request the storage space from an operating system; and
receive indication of the requested storage space from the operating system.

46. The program storage device of claim 45, further comprising instructions to:
compare the size of the acquired storage space with the total space required by the database data set as indicated by the database control block; and
acquire additional storage space approximately equal to the difference between the acquired storage space and the total space required by the database data set.

47. The program storage device of claim 46, wherein the instructions to acquire additional storage space comprise instructions to issue one or more requests for said additional storage space from the operating system.

48. The program storage device of claim 47, wherein the instructions to accept additional storage space comprise instructions to accept storage space on a second direct access storage device, wherein the second direct access storage device is different from the first direct access storage device.

49. The program storage device of claim 42, wherein the instructions to scan and acquire are directed to a database selected from the group consisting of a Data Entry Database, a Hierarchical Direct Access Method database and a Hierarchical Indexed Direct Access Method database.

50. The program storage device of claim 42, wherein the instructions to scan and acquire are directed to a relational database.

51. The program storage device of claim 41, wherein the instructions to acquire storage space comprise instructions to determine whether the database data set is a Virtual Storage Access Method data set.

52. The program storage device of claim 41, wherein the instructions to open comprise instructions to invoke a Media Manager service to open the accepted storage space to the database data set.
